(19) United States
(12) Patent Application Publication
(10) Pub. No.: US 2019/0177573 A1
(43) Pub. Date: Jun. 13, 2019

(54) Curable Silsesquioxane Polymer Comprising Inorganic Oxide Nanoparticles, Articles, and Methods

(71) Applicant: 3M INNOVATIVE PROPERTIES COMPANY, St. Paul, MN (US)

(72) Inventors: Jitendra S. Rathore, Woodbury, MN (US); Claire Hartmann-Thompson, Lake Elmo, MN (US)

(21) Appl. No.: 16/323,662

(22) PCT Filed: Aug. 25, 2017
(86) PCT No.: PCT/IB2017/055134

§ 371 Date: Feb. 6, 2019

Related U.S. Application Data
(60) Provisional application No. 62/381,796, filed on Aug. 31, 2016.

(51) Int. Cl. C09D 183/04; C09D 7/20; C09D 7/62; C08G 77/04; C08K 3/22; C08K 9/06

(52) U.S. Cl. CPC C09D 183/04; C09D 7/20; C09D 7/62; C08G 77/70; C08K 3/22; C08K 9/06; C08G 77/045

(57) ABSTRACT

A curable coating composition is described comprising a silsesquioxane polymer comprising first non-hydrolyzed functional groups; inorganic oxide nanoparticles; and at least one silane compound comprising a second functional group wherein the second functional group covalently bonds with the first non-hydrolyzed functional groups of the silsesquioxane polymer. Preferably, the silane compound further covalently bonds to the inorganic oxide nanoparticles. Preferably, the first non-hydrolyzed functional groups are independently selected from an ethylenically unsaturated group, epoxy, mercapto, amino, and isocyanato. Also describes are method of making an article and articles comprising a curable or cured composition as described herein. In one embodiment, the cured composition comprises inorganic oxide nanoparticles covalently bonded to non-hydrolyzed functional groups of a silsesquioxane polymer matrix.

### SUMMARY

In one embodiment, a curable composition is described comprising a silsesquioxane polymer comprising first non-hydrolyzed functional groups; inorganic oxide nanoparticles; and at least one silane compound comprising a second functional group wherein the second functional group covalently bonds with the first non-hydrolyzed functional groups of the silsesquioxane polymer.

In some embodiments the first and second functional group are selected from an ethylenically unsaturated group, epoxy, mercapto, amino, and isocyanato.

In favored embodiments, the silsesquioxane polymer is end-capped such that it contains little or no —OH groups.

In another embodiment, a method of making an article is described comprising disposing the described curable composition on at least a portion of at least one surface of a substrate; and thermally and/or radiation curing the curable composition such that the first and second functional groups covalently bond.

Also described are articles comprising a curable or cured composition as described herein. In one embodiment, the cured composition comprises inorganic oxide nanoparticles covalently bonded to non-hydrolyzed functional groups of a silsesquioxane polymer matrix.

### DETAILED DESCRIPTION

A silsesquioxane is an organosilicon compound with the empirical chemical formula R′SiO_{3/2} where Si is the element silicon, O is oxygen and R′ is either hydrogen or an aliphatic or aromatic organic group that optionally further comprises an ethylenically unsaturated group. Thus, silsesquioxanes polymers comprise silicon atoms bonded to three oxygen atoms. Silsesquioxanes polymers that have a random branched structure are typically liquids at room temperature. Silsesquioxanes polymers that have a non-random structure like cubes, hexagonal prisms, octagonal prisms, decagonal prisms, and dodecagonal prisms are typically solids as room temperature.

Silsesquioxanes polymers differ from polysiloxanes. The silicon atoms of the backbone of a polysiloxane are bonded to two oxygen atoms and typically two methyl groups. Polysiloxanes are typically linear in structure.

The silsesquioxane polymer can be a homopolymer or copolymer. As used herein, the term “polymer” refers to the homopolymer and copolymer unless indicated otherwise.

The silsesquioxane polymer comprises a three-dimensional branched network term three-dimensional branched network or in otherwords a branched silsesquioxane polymer.

The silsesquioxane polymer further comprises first non-hydrolyzed functional groups (R^{X1}). The first non-hydrolyzed functional groups (R^{X1}) can be crosslinked with the second functional group of the silane compound. Prior to such crosslinking, the curable silsesquioxane polymer can be considered a precursor that has not yet reached its gel point.

In one embodiment, the silsesquioxane polymer comprises a three-dimensional branched network having the formula:

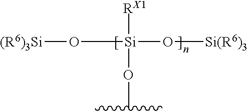

wherein the oxygen atom at the * is bonded to another Si atom within the three-dimensional branched network, wherein R^{X1} is independently a first non-hydrolyzed functional organic group; R⁶ are independently a hydrolyzed (e.g. —OH) group, a non-hydrolyzed group, or a combination thereof; and n is at least 3. In favored embodiments, R⁶ is a non-hydrolyzed group.

In another embodiment, the silsesquioxane polymer comprises a three-dimensional branched network having the formula:

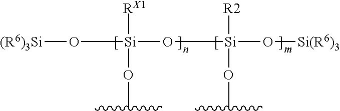

wherein the oxygen atom at the * is bonded to another Si atom within the three-dimensional branched network, R^{X1} is independently a first non-hydrolyzed functional organic group; R⁶ are independently a hydrolyzed (e.g. —OH) group, a non-hydrolyzed group, or a combination thereof; and n+m is an integer of greater than 3. In favored embodiments, R⁶ is a non-hydrolyzed organic group.

The SSQ polymer comprises at least two non-hydrolyzed functional organic groups, R^{X1}. Thus, n is an integer of at least 2 and in some embodiments at least 3, 4, 5, 6, 7, 8 or 9. For embodiments wherein the silsesquioxane polymer is a copolymer comprising both n and m units, m is at least 1, 2, 3, 4, 5, 6, 7, 8, 9 and the sum of n+m is an integer of 3 or greater than 3. In certain embodiments, n, m, or n+m is an integer of at least 10, 15, 20, 25, 30, 35, 40, 45, or 50. In certain embodiments, n or m is an integer of no greater than 500, 450, 400, 350, 300, 250, or 200. Thus, n+m can range up to 1000. In certain embodiments, n+m is an integer of no greater than 175, 150, or 125. In some embodiments, n and m are selected such the copolymer comprises at least 25, 26, 27, 28, 29, or 30 mol % of repeat units comprising first non-hydrolyzed functional groups, R^{X1}. In some embodiments, n and m are selected such the copolymer comprises no greater than 85, 80, 75, 70, 65, or 60 mol % of repeat units comprising first non-hydrolyzed functional groups, R^{X1}.

In one embodiment, the curable silsesquioxane polymer comprises a three-dimensional branched network that is a reaction product of a compound having the formula X—Y—Si(R¹)₃. In this embodiment, R^{X1} has the formula Y—X.

The Y group is typically a covalent bond (as depicted in the above formulas), or is a divalent organic group selected from alkylene group, arylene, alkyarylene, and arylalkylene group. In certain embodiments, Y is a (C1-C20)alkylene group, a (C6-C12)arylene group, a (C6-C12)alk(C1-C20)arylene group, a (C6-C12)ar(C1-C20)alkylene group, or a combination thereof. Y may optionally further comprise (e.g. contiguous) oxygen, nitrogen, sulfur, silicon, or halogen substituents, and combinations thereof. In some embodiments, Y does not comprise oxygen or nitrogen substituents that can be less thermally stable.

The group X is a non-hydrolyzed functional (e.g. terminal) group that covalently bonds with the second functional group of the nanoparticles. In some embodiments, X is an ethylenically unsaturated group such as a vinyl group, a vinylether group, a (meth)acryloyloxy group, and a (meth)acryloylamino group (including embodiments wherein the nitrogen is optionally substituted with an alkyl such as methyl or ethyl). In certain embodiments, X is a vinyl group. When Y is alkylene and X is a vinyl group, Y—X is an alkenyl group. Such alkenyl group may have the formula (H₂C═CH(CH₂)ₙ— wherein —(CH₂) n is alkylene as previously defined. In other embodiments, X is a functional group that is not an ethylenically unsaturated group such as an epoxy group, an amino group, a mercapto group, or an isocyanato group.

The curable silsesquioxane polymer can be made by hydrolysis and condensation of reactants of the formula X—Y—Si(R¹)₃. Examples of such reactants include but are not limited to vinyltriethoxysilane, allyltriethoxysilane, allylphenylpropyltriethoxysilane, 3-butenyltriethoxysilane, docosenyltriethoxysilane, and hexenyltriethoxysilane and trialkoxysilanes comprising a reactive group that is not an ethylenically unsaturated group such as glycidoxypropyltriethoxysilane; (3-glycidoxypropyltriethoxysilane 5,6-epoxyhexyltriethoxysilane; 2-(3,4-epoxycyclohexyl)ethyltriethoxysilane 3-(diphenylphosphino)propyltriethoxysilane; mercaptopropyltriethoxysilane; s-(octanoyl)mercaptopropyltriethoxysilane; 3-isocyanatopropyltriethoxysilane; hydroxy(polyethyleneoxy)propylltriethoxysilane; hydroxymethyltriethoxysilane; 3-cyanopropyltriethoxysilane; 2-cyanoethyltriethoxysilane; 2-(4-pyridylethyl)triethoxysilane; (n,n-diethylaminomethyl)triethoxysilane; n-cyclohexylaminomethyl)triethoxysilane; n,n-bis(2-hydroxyethyl)-3-aminopropyltriethoxysilane; 11-chloroundecyltriethoxysilane; 3-chloropropyltriethoxysilane; p-chlorophenyltriethoxysilane; chlorophenyltriethoxysilane; and 2-[(acetoxy(polyethyleneoxy)propyl]triethoxysilane.

Hydrolysis and condensation of such reactants can be carried out using conventional techniques, such as exemplified in the examples section.

In another embodiment, the curable silsesquioxane copolymer comprises a three-dimensional branched network that is a reaction product of at least one compound having the formula X—Y—Si(R¹)₃ and at least one compound having the formula Z—Y—Si(R¹)₃. In this embodiment, R^{X1} has the formula Y—X and R2 has the formula Y—Z. Y and X are the same as previously described.

The Z group typically does not covalently bond with the second functional group of the silane compound. The Z group is typically hydrogen or a (monovalent) organic group selected from alkyl, aryl, alkaryl, aralkyl, that are optionally comprise halogen or other substituents. X may optionally further comprise (e.g. contiguous) oxygen, nitrogen, sulfur, silicon, substituents. In some embodiments, X is an optionally halogenated (C1-C20)alkyl group such as (C4-C6) fluoroalkyl, a (C6-C12)aryl group, a (C6-C12)alk(C1-C20)aryl group, a (C6-C12)ar(C1-C20)alkyl group,

The curable silsesquioxane polymers can be made by the hydrolysis and condensation of reactants of the formula X—Y—Si(R¹)₃, as previously described and Z—Y—Si(R¹)₃. Examples of reactants of the formula Z—Y—Si(R¹)₃ include but are not limited to aromatic trialkoxysilanes such as phenyltrimethoxylsilane, (e.g. C1-C12) alkyl trialkoxysilanes such as methyltrimethoxylsilane, fluoroalkyl trialkoxysilanes such as nonafluorohexyltriethoxysilane.

Commercially available Z—Y—Si(R¹)₃ reactants include for example trimethylsiloxytriethoxysilane; p-tolyltriethoxysilane; tetrahydrofurfuryloxypropyltriethoxysilane; n-propyltriethoxysilane; (4-perfluorooctylphenyl)triethoxysilane; pentafluorophenyltriethoxysilane; nonafluorohexyltriethoxysilane; 1-naphthyltriethoxysilane; 3,4-methylenedioxyphenyltriethoxysilane; p-methoxyphenyltriethoxysilane; 3-isooctyltriethoxysilane; isobutyltriethoxysilane; (heptadecafluoro-1,1,2,2-tetrahydrodecyl)triethoxysilane; 3,5-dimethoxyphenyltriethoxysilane; butylpoly(dimethylsiloxanyl)ethyltriethoxysilane; and benzyltriethoxysilane.

In each of the formulas X—Y—Si(R¹)₃ and Z—Y—Si(R¹)₃, R¹ is independently a hydrolyzable group, that is preferably converted to a hydrolyzed group, such as —OH, during hydrolysis. The Si—OH groups react with each other to form silicone-oxygen linkages such that the majority of silicon atoms are bonded to three oxygen atoms. After hydrolysis, the —OH groups can be further reacted with an end-capping agent to convert the hydrolyzed group, e.g. —OH, to —OSi(R³)₃. The silsesquioxane polymer may comprise terminal groups having the formula —Si(R³)₃ after end-capping.

Various alkoxy silane end-capping agents are known. In some embodiments, the end-capping agent has the general structure R⁵OSi(R³)₃ or O[Si(R³)₃]₂ wherein R⁵ is a hydrolyzable group such as methoxy or ethoxy and R³ is independently a non-hydrolyzable (organic) group. Thus, in some embodiments R³ generally lacks an oxygen atom or a halogen directly bonded to a silicon atom. Thus, R³ generally lacks an alkoxy group. R³ is typically independently alkyl, aryl (e.g. phenyl), or combination thereof (e.g. aralkylene, alkarylene); that optionally comprises halogen substituents (e.g. chloro, bromo, fluoro). The optionally substituted alkyl group may have a straight, branched, or cyclic structure. In some embodiments, R³ is C₁-C₁₂ or C₁-C₄ alkyl optionally comprising halogen substituents. R³ may optionally comprise (e.g. contiguous) oxygen, nitrogen, sulfur, or silicon substituents. In some embodiments, R³ does not comprise oxygen or nitrogen substituents that can be less thermally stable.

A non-limiting list of illustrative end-capping agents and the resulting R³ groups is as follows:

| End-capping agent | R³ |
|---|---|
| n-butyldimethylmethoxysilane | n-butyldimethyl |
| t-butyldiphenylmethoxysilane | t-butyldiphenyl |
| 3-chloroisobutyldimethylmethoxysilane | 3-chloroisobutyldimethyl |
| phenyldimethylethoxysilane | phenyldimethyl |
| n-propyldimethylmethoxysilane | n-propyldimethyl |
| triethylethoxysilane | triethyl |
| trimethylmethoxysilane | trimethyl |
| triphenylethoxysilane | triphenyl |
| n-octyldimethylmethoxysilane | n-octyldimethyl |
| Hexamethyldisiloxane | trimethyl |
| hexaethyldisiloxane | triethyl |
| 1,1,1,3,3,3-hexaphenyldisiloxane | triphenyl |
| 1,1,1,3,3,3-hexakis(4- | tri-[4-(dimethylamino)phenyl] |
| (dimethylamino)phenyl)disiloxane | |
| 1,1,1,3,3,3-hexakis(3- | tri-(3-fluorobenzyl) |
| fluorobenzyl)disiloxane | |

Many of the above end-capping agents can also be utilized as Z—Y—Si(R¹)₃ reactants.

In some embodiments, the curable silsesquioxane polymer is free of hydrolyzed groups such as —OH group. In other embodiments, the curable silsesquioxane polymer further comprises hydrolyzed groups such as —OH groups. In some embodiments, the amount of hydrolyzed groups (e.g. —OH groups) is no greater than 15, 10, or 5 wt.-%. In still other embodiments, the amount of hydrolyzed groups (e.g. —OH groups) is no greater than 4, 3, 2 or 1 wt-%. The curable silsesquioxane polymer and nanoparticle-containing composition can exhibit improved shelf life in comparison to curable silsesquioxane polymers having higher concentrations of —OH groups.

When the curable silsesquioxane polymer comprises little or no hydrolyzed groups (e.g. —OH groups), the cured silsesquioxane polymer and nanoparticle-containing composition can exhibit better thermal stability in comparison to silsesquioxane polymers having higher concentrations of —OH groups. Reducing the concentration of —OH groups can result in the cured silsesquioxane polymer as well as cured nanoparticle-containing silsesquioxane polymer matrix exhibiting a substantially lower weight loss when heated as can be determined by thermogravimetric analysis as further described in the examples. In some embodiments, the cured silsesquioxane polymer has a weight loss of less than 20% or 15% when heat 30° C. to 600° C. at a heating rate of 10° C./minute.

Prior to end-capping, illustrative curable silsesquioxane polymers prepared from reactants of the formula X—Y—Si(R¹)₃ are as follows:

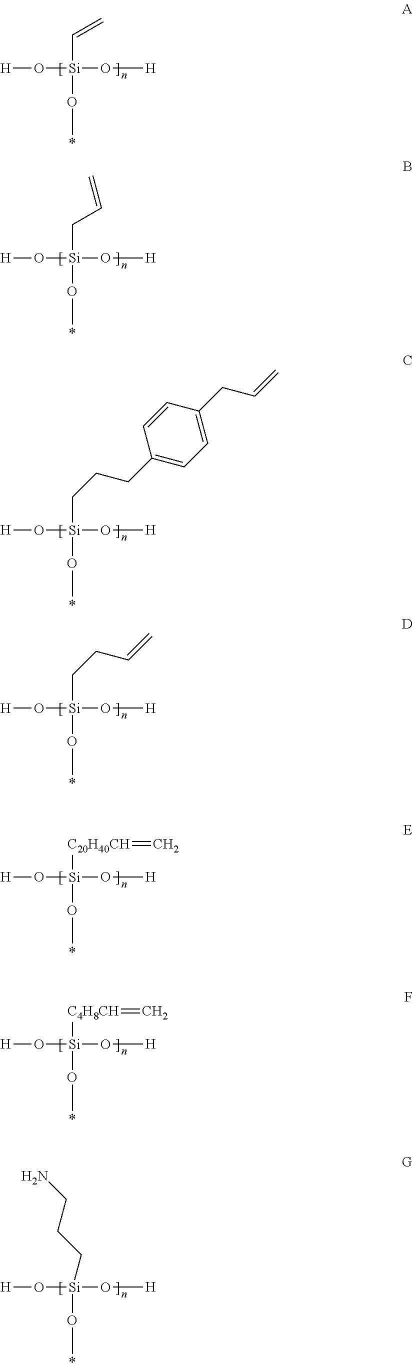

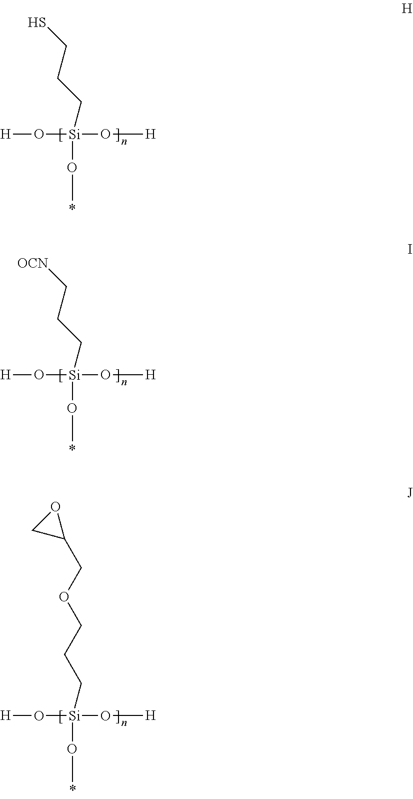

Polymers made from such reactants of the formula X—Y—Si(R¹)₃ are poly(vinylsilsesquioxane) (A), poly(allylsilsesquioxane) (B), poly(allylphenylpropylsilsesquioxane) (C), poly(3-butenylsilsesquioxane) (D), poly(docosenyl silsesquioxane) (E), poly(hexenylsilsesquioxane) (F), poly(aminopropylsilsesquioxane) (G), poly(mercaptopropylsilsesquioxane) (H), poly(isocyanatopropylsilsesquioxane) (I), and poly(glycidoxypropylsilsesquioxane) (J)

In one naming convention, the R³ group derived from the end-capping agent is included in the name of the polymer. One illustrative curable silsesquioxane polymer end-capped with ethoxytrimethylsilane is trimethyl silyl poly(vinylsilsesquioxane) having the general formula:

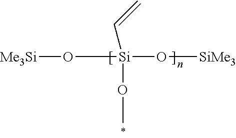

wherein the oxygen atom in the formula above at the * above is bonded to another Si atom within the three-dimensional branched network.

The methyl end groups of SiMe₃ can be any other non-hydrolyzed group or hydrolyzed (e.g. —OH) group.

In some embodiments, curable silsesquioxane copolymers can be made with two or more reactants of the formula X—Y—Si(R¹)₃. For example, vinyltriethoxylsilane or allytriethoxysilane can be coreacted with an alkenylalkoxylsilane such as 3-butenyltriethoxysilane and hexenyltriethoxysilane. Alternatively, at least one reactant of the formula X′—Y—Si(R¹)₃ wherein X′ is an ethylenically unsaturated group can be coreacted with at least one reactant of the formula X″—Y—Si(R¹)₃ wherein X″ is a different functional group that is not an ethylenically unsaturated group. One representative curable silsesquioxane copolymers has the general formula:

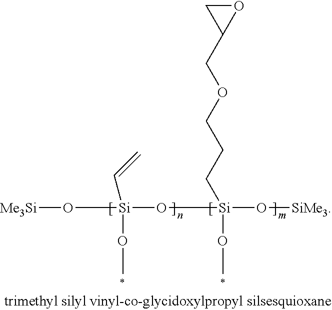

The methyl end groups of SiMe₃ can be any other non-hydrolyzed group or hydrolyzed (e.g. —OH) group, as previously described.

In other embodiments, curable silsesquioxane copolymers can be made with at least one reactant of the formula X—Y—Si(R¹)₃ and at least one reactant of the formula Z—Y—Si(R¹)₃. Representative curable silsesquioxane copolymers have the general formula:

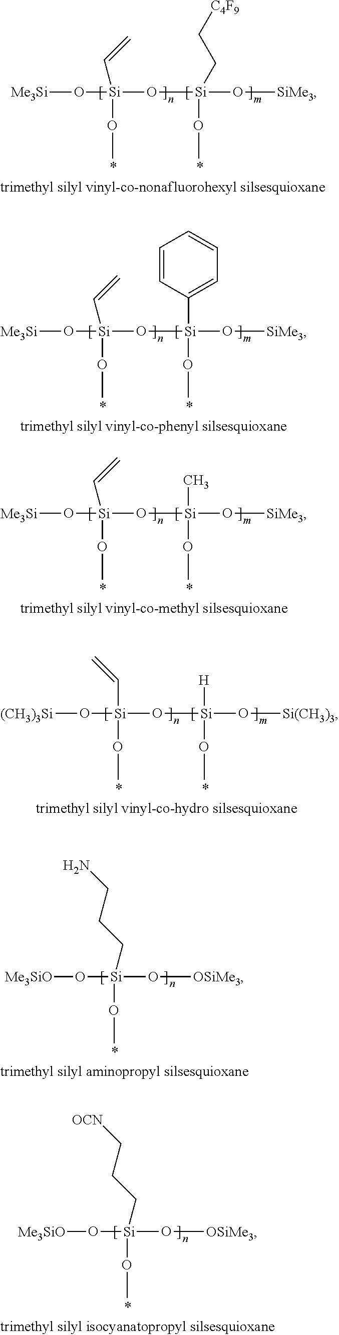

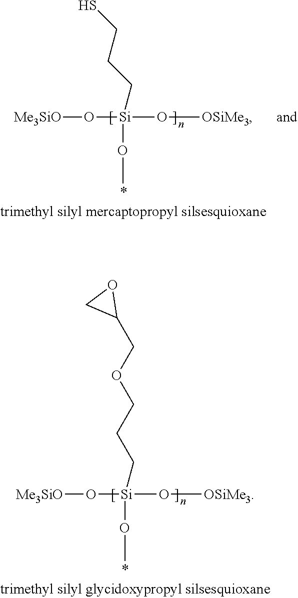

In each of the formulas depicted herein, one or more of the methyl end groups of SiMe₃ can be any other non-hydrolyzed group or a hydrolyzed (e.g. —OH) group, as previously described.

The inclusion of the co-reactant of the formula Z—Y—Si(R¹)₃ can be used to enhance certain properties depending on the selection of the R2 group. For example, when R2 comprises an aromatic group such as phenyl, the thermal stability can be improved (relative to a homopolymer of vinyltrimethoxysilane). Further, when R2 comprises a fluoroalkyl group, the hydrophobicity can be improved.

The amount of reactant(s) of the formula X—Y—Si(R¹)₃ can range up to 100 mol % in the case of homopolymers. The copolymers typically comprise no greater than 99, 98, 97, 96, 95, 94, 93, 92, 91, or 90 mol % of reactant(s) of the formula Z—Y—Si(R¹)₃. In some embodiments, the amount of reactant(s) of the formula X—Y—Si(R¹)₃ is no greater than 85, 80, 75, 70, or 60 mol %. In some embodiments, the amount of reactant(s) of the formula X—Y—Si(R¹)₃ is at least 15, 20, 25, or 30 mol %.

The amount of reactant(s) of the formula Z—Y—Si(R¹)₃ can be as little as 1, 2, 3, 4, 5, 6, 7, 8, 9, or 10 mol % of the copolymer. The amount of reactant(s) of the formula Z—Y—Si(R¹)₃ is typically no greater than 75 mol % or 70 mol %. In some embodiments, the amount of reactant(s) of the formula Z—Y—Si(R¹)₃ is at least 15, 20, 25, or 30 mol %. In some embodiments, the amount of reactant(s) of the formula Z—Y—Si(R¹)₃ is no greater than 65 or 60 mol %. It is appreciated that the amount of reactants of the formula Z—Y—Si(R¹)₃ or X—Y—Si(R¹)₃ is equivalent to the amount of repeat units derived from Z—Y—Si(R¹)₃ or X—Y—Si(R¹)₃. In some embodiments the molar ratio of reactant(s) of the formula X—Y—Si(R¹)₃ to molar ratio to reactant(s) of the formula Z—Y—Si(R¹)₃ ranges from about 10:1; 15:1, or 10:1 to 1:4; or 1:3, or 1:2.

In some embodiments, the curable SSQ polymer comprises a core comprising a first silsesquioxane polymer and an outer layer comprising a second silsesquioxane polymer bonded to the core. The silsesquioxane polymer of the core, outer layer, or combination thereof comprises first non-hydrolyzed functional groups, as previously described. Such curable SSQ polymers are described in WO2015/195268 and WO2016/048736; incorporated herein by reference.

The curable SSQ polymer is the predominant polymer of the composition. The SSQ polymer matrix typically does not include other thermoset or thermoplastic polymers in the matrix. Thus, the polymer matrix comprises less than 10, 5, 3, 2, or 1 wt-% of polymers that are not SSQ polymer.

The curable composition further comprises inorganic oxide nanoparticles. Nanoparticles are present in the composition in an amount effective to enhance the durability and/or increase the refractive index of the composition. It may be desirable to employ a mixture of inorganic oxide particle types to optimize an optical or other material property.

Suitable nanoparticles can include an oxide of a non-metal, an oxide of a metal, or combinations thereof. An oxide of a non-metal includes an oxide of, for example, silicon or germanium. An oxide of a metal includes an oxide of, for example, iron, titanium, cerium, aluminum, zirconium, vanadium, zinc, antimony, and tin. A combination of a metal and non-metal oxide includes an oxide of aluminum and silicon.

In some favored embodiments, the size of the nanoparticles is typically chosen to avoid significant visible light scattering. The surface modified colloidal nanoparticles can be oxide particles having a (e.g. unassociated) primary particle size or associated particle size of greater than 1 nm, 5 nm or 10 nm. The primary or associated particle size is generally and less than 100 nm, 75 nm, or 50 nm. Typically the primary or associated particle size is less than 40 nm, 30 nm, or 20 nm. It is preferred that the nanoparticles are unassociated. Their measurements can be based on transmission electron microscopy (TEM).

In some embodiments, the inorganic oxide nanoparticles having a refractive index of at least 1.68, typically ranging up to about 2.0. Inclusion of such can raise the refractive index of the cured nanoparticle-containing silsesquioxane polymer matrix. The high refractive index nanoparticles can include metal oxides such as, for example, alumina, zirconia, titania, mixtures thereof, or mixed oxides thereof.

The refractive index of the cured composition is greater than 1.46, 1.47, 1.48, or 1.50. In some embodiments, the refractive index is at least 1.55, 1.65, 1.60, 1.65, 1.70, 1.75, 1.80, 1.85 or 1.90, as measured according to the test method described in the forthcoming examples. The refractive index of the cured composition is less than the refractive index of the high refractive index nanoparticles, e.g. less than 2.0.

Various nanoparticles are commercially available. In some embodiments, the nanoparticles may be in the form of a colloidal dispersion. Colloidal silica nanoparticles in a polar solvent are particularly desirable. Silica sols in a polar solvent such as isopropanol are available commercially under the trade names ORGANOSILICASOL IPA-ST-ZL, ORGANOSILICASOL IPA-ST-L, and ORGANOSILICASOL IPA-ST from Nissan Chemical Industries, Ltd., Chiyoda-Ku Tokyo, Japan. Titanium dioxide nanoparticle in the form of an aqueous dispersion can be obtained from Showa Denko K. K., Tokyo, Japan.

Nanoparticles can also be made using techniques known in the art. For example, zirconia nanoparticles can be prepared using hydrothermal technology, as described for example in PCT Publication No. WO2009/085926 (Kolb et al.). Suitable zirconia nanoparticles are also those described in, for example, U.S. Pat. No. 7,241,437 (Davidson et al.).

The nanoparticles are combined with a surface treatment compound in order to obtain surface treated nanoparticles. At least one of the surface treatment compounds has one end that bonds to the surface of the nanoparticles and an opposing end comprising a second functional group. The second functional group covalently bonds with the first non-hydrolyzed functional groups of the silsesquioxane polymer. The surface treatment compounds are generally small molecules having a molecular weight ranging of at least 30 g/mole typically ranging up to 250, 300, 350, 400, 450, or 500 g/mole.

One common surface treatment compound is a silane coupling agent. Silane coupling agents typically have the general structure

R^{X2}—(CH₂)n-Si(R⁵)₃

wherein R^{X2} is a second functional group R⁵ is a hydrolyzable group. In typical embodiments, R⁵ is methoxy and n is 1, 2 or 3.

Various silane coupling agent are commercially available from various suppliers including Gelest and Momentive Performance Materials. Some representative silane coupling agents include for example vinyltrimethoxysilane, mercaptopropyltrimethoxysilane, aminopropyltrimethoxysilane, methacryloxypropyltrimethoxysilane, acryloxypropyltrimethoxysilane, isocyanatopropyltrimethoxysilane, glyclidoxypropyltrimethoxysilane, aminoethylaminopropyltrimethoxysilane, aminophenyltrimethoxysilane, and glycidyloxypropyltrimethoxysilane.

Many of the previously described reactants of the formula X—Y—Si(R¹)₃ can be utilized as the silane coupling agent.

It is appreciated the first functional group of the curable SSQ polymer and the second functional group of the surface treatment compound are selected such that the functional groups form a covalent bond during drying and/or curing of the composition. Some representative combinations of first and second functional groups are as follows:

| First Functional | Second Functional Group of | |
|---|---|---|
| Group of SSQ | Surface Treated | |
| Polymer | Nanoparticles | Cure Type |
| epoxy | mercapto | Thermal |
| vinyl | mercapto | UV |
| (meth)acryl | mercapto | UV |
| epoxy | amino | Thermal |
| (meth)acryl | amino | UV |
| mercapto | (meth)acryl | UV |
| mercapto | vinyl | UV |

In some embodiments, when the first non-hydrolyzed functional group is an ethylenically unsaturated group and the second functional groups of the surface treated nanoparticles is not an ethylenically unsaturated group.

In some embodiments, a combination of surface treatment compounds are utilized wherein at least one of the surface treatment compound comprise a second functional group as previously described and the second surface treatment compound does not comprises a second functional group. The second surface treatment may comprise a hydrophilic group such as in the case of polyalkyleneoxidealkoxysilane.

The surface modification of the nanoparticles in the colloidal dispersion can be accomplished in a variety of ways. The process generally involves the mixture of an inorganic particle dispersion with surface treatment compounds. Optionally, a co-solvent can be added at this point, such as for example, 1-methoxy-2-propanol, ethanol, isopropanol, ethylene glycol, N,N-dimethylacetamide and 1-methyl-2-pyrrolidinone. The co-solvent can enhance the solubility of the surface modifying agents as well as the surface modified particles. The mixture comprising the inorganic sol and surface treatment compounds is subsequently reacted at room or an elevated temperature, with or without mixing.

Preferably, the surface treated nanoparticles are dispersed in a coating composition comprising the functionalized SSQ polymer. The nanoparticles are typically present in a curable composition in an amount of at least 5, 10, 15, 20, 25, or 30 wt-%, based on the total weight of the composition. In some embodiments, the nanoparticles are present in a curable composition in an amount of at least 35, 40, 45, 50, 55, 60, 75, or 80 wt-%, based on the total weight of the composition. The maximum concentration of nanoparticles typically does not exceed 90 wt-%.

A coating composition that includes silsesquioxane polymer and nanoparticles, can also include an optional organic solvent, if desired. Useful solvents for the coating compositions include those in which the compound is soluble at the level desired. Typically, such organic solvent is a polar organic solvent. Exemplary useful polar solvents include, but are not limited to, ethanol, isopropanol, methyl ethyl ketone, methyl isobutyl ketone, dimethylformamide, and tetrahydrofuran. These solvents can be used alone or as mixtures thereof.

Any amount of the optional organic solvent can be used. For example, the coating compositions can include up to 50 wt-% or even more of organic solvent. The solvent can be added to provide the desired viscosity to the coating composition. In some embodiments, no solvent or only low levels (e.g., up to 10 wt-%) of organic solvent is used in the curable coating composition.

In some embodiments, the curable silsesquioxane polymers are generally tacky, soluble in organic solvents (particularly polar organic solvents), and coatable. Thus, such curable silsesquioxane polymers can be easily processed. The compositions can be easily applied to a substrate and adhere well to a variety of substrates. For example, in certain embodiments, especially those having a low concentration of nanoparticles (<10 wt.-%), the composition has peel force from glass of at least 0.1, 0.2, 0.3, 0.4, 0.5 or 1 Newton per decimeter (N/dm), or at least 2 N/dm and typically no greater than 6 N/dm, per the Method for Peel Adhesion Measurement described in WO 2015/088932.

In other embodiments, the curable silsesquioxane polymer can provide a (e.g. weatherable) protective hard coating that has multiple applications. For example, such coatings can be used as anti-scratch and anti-abrasion coatings for various polycarbonate lens and polyesters films, which require additional properties such as optical clarity, durability, hydrophobicity, etc., or any other application where use of temperature, radiation, or moisture may cause degradation of films.

In some embodiments, the cured composition has a haze less than 5, 4, 3, or 2%. In some embodiments, the transmittance is at least 90, 91, 92, or 93%. The haze and transmittance can be measured according to the test methods described in the examples.

In some embodiments the curable compositions, as described herein, optionally further comprise a photoinitiator. Suitable photoinitiators include a variety of free-radical photoinitiators. Exemplary free-radical photoinitiators can be selected from benzophenone, 4-methylbenzophenone, benzoyl benzoate, phenylacetophenones, 2,2-dimethoxy-2-phenylacetophenone, alpha,alpha-diethoxyacetophenone, 1-hydroxy-cyclohexyl-phenyl-ketone (available under the trade designation IRGACURE 184 from BASF Corp., Florham Park, N.J.), 2-hydroxy-2-methyl-1-phenylpropan-1-one, bis-(2,6-dimethoxybenzoyl)-2,4,4-trimethylpentyl phosphine oxide, 2-hydroxy-2-methyl-1-phenylpropan-1-one, 2-hydroxy-2-methyl-1-phenylpropan-1-one (available under the trade designation DAROCURE 1173 from BASF Corp.), 2,4,6-trimethylbenzoyl-diphenylphosphine oxide, and combinations thereof (e.g., a 50:50 by wt. mixture of 2,4,6-trimethylbenzoyl-diphenylphosphine oxide and 2-hydroxy-2-methyl-1-phenylpropan-1-one, available under the trade designation DAROCURE 4265 from BASF Corp.).

When present, a photoinitiator is typically present in the composition in an amount of at least 0.01 percent by weight (wt-%), based on the total weight of curable material in the coating composition. A photoinitiator is typically present in a coating composition in an amount of no greater than 5 wt-%, based on the total weight of curable material in the coating composition.

The composition can optionally be combined with a hydrosilylation catalyst and optionally a polyhydrosiloxane crosslinker and thermally cured by heating the curable coating.

Various hydrosilylation catalysts are knows. For examples, numerous patents describe the use of various complexes of cobalt, rhodium or platinum as catalysts for accelerating the thermally-activated addition reaction between a compound containing silicon-bonded to hydrogen and a compound containing aliphatic unsaturation. Various platinum catalyst are known such as described in U.S. Pat. Nos. 4,530,879; 4,510,094; 4,600,484; 5,145,886; and EP 0 398701; incorporated herein by reference. In one embodiment, the catalyst is a complex comprising platinum and an unsaturated silane or siloxane as described in U.S. Pat. No. 3,775,452; incorporated herein by reference. One exemplary catalyst of this type bis(1,3-divinyl-1,1,3,3-tetrametyldisiloxane) platinum.

Various hydrosiloxane crosslinkers are known. Hydrosiloxane crosslinkers have the following general formula.

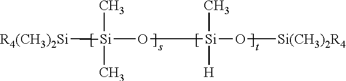

wherein T can be 0, 1, 2 and is typically less than 300;
S can be 0, 1, or 2 and is typically less than 500; and
R₄ is independently hydrogen or a C₁-C₄ alkyl and more typically H, methyl or ethyl; and with the proviso that when T is 0 at least one R₄₋is hydrogen.

When utilized such siloxane crosslinkers are typically present in an amount no greater than 5 wt-%.

The composition is typically a homogeneous mixture that has a viscosity appropriate to the application conditions and method. For example, a material to be brush or roller coated would likely be preferred to have a higher viscosity than a dip coating composition. Typically, a coating composition includes at least 5 wt-% of solids (SSQ polymer and nanoparticles), based on the total weight of the coating composition. A coating composition often includes no greater than 80 wt-% solids, based on the total weight of the coating composition.

A wide variety of coating methods can be used to apply a composition of the present disclosure, such as brushing, spraying, dipping, rolling, spreading, and the like. Other coating methods can also be used, particularly if no solvent is included in the coating composition. Such methods include knife coating, gravure coating, die coating, and extrusion coating, for example.

The composition can be applied in a continuous or patterned layer. Such layer can be disposed on at least a portion of at least one surface of the substrate. If the composition includes an organic solvent, the coated curable composition can be exposed to conditions that allow the organic solvent to evaporate from the curable composition before UV curing the curable composition. Such conditions include, for example, exposing the composition to room temperature, or an elevated temperature (e.g., 60° C. to 70° C.).

Curing of a composition of the present disclosure can be accomplished by thermal curing (e.g. to a temperature ranging from about 50 to 120° C.) or radiation curing, such as exposure to UV radiation. Typically, the curing occurs for a time effective to render the coating sufficiently non-tacky to the touch.

In some embodiments, the pencil hardness after curing is at least 3B, B, HB, H, 2H, 3H, 4H, 5H, and 6H. Due to addition of titania or zirconia nanoparticles, the hardness of the coating can substantially increase as compared to SSQ in the absence of nanoparticles.

The substrate on which the coating can be disposed can be any of a wide variety of hard or flexible materials. Useful substrates include ceramics, siliceous substrates including glass, metal, natural and man-made stone, and polymeric materials, including thermoplastics and thermosets. Suitable materials include, for example, poly(meth)acrylates, polycarbonates, polystyrenes, styrene copolymers such as styrene acrylonitrile copolymers, polyesters, polyethylene terephthalate.

As used herein, the term “organic group” means a hydrocarbon group (with optional elements other than carbon and hydrogen, such as oxygen, nitrogen, sulfur, silicon, and halogens) that is classified as an aliphatic group, cyclic group, or combination of aliphatic and cyclic groups (e.g., alkaryl and aralkyl groups). In the context of the present invention, the organic groups are those that do not interfere with the formation of curable silsesquioxane polymer. The term “aliphatic group” means a saturated or unsaturated linear or branched hydrocarbon group. This term is used to encompass alkyl, alkenyl, and alkynyl groups, for example. The term “alkyl group” is defined herein below. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” are defined herein below. The term “heterocyclic group” means a closed ring hydrocarbon in which one or more of the atoms in the ring is an element other than carbon (e.g., nitrogen, oxygen, sulfur, etc.). The organic group can have any suitable valency but is often monovalent or divalent.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of alkylene groups include, but are not limited to, methylene, ethylene, 1,3-propylene, 1,2-propylene, 1,4-butylene, 1,4-cyclohexylene, and 1,4-cyclohexyldimethylene.

The term “alkoxy” refers to a monovalent group having an oxy group bonded directly to an alkyl group.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Any additional rings can be unsaturated, partially saturated, or saturated. Optionally, an aromatic ring can have one or more additional carbocyclic rings that are fused to the aromatic ring. Unless otherwise indicated, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

The term “aralkylene” refers to a divalent group that is an alkylene group substituted with an aryl group or an alkylene group attached to an arylene group. The term “alkarylene” refers to a divalent group that is an arylene group substituted with an alkyl group or an arylene group attached to an alkylene group. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms.

The term “hydrolyzable group” refers to a group that can react with water having a pH of 1 to 10 under conditions of atmospheric pressure. The hydrolyzable group is often converted to a hydroxyl group when it reacts. Typical hydrolyzable groups include, but are not limited to, alkoxy, aryloxy, aralkyloxy, alkaryloxy, acyloxy, or a halogen (directly bonded to a silicon atom). The hydrolysis reaction converts the hydrolyzable groups to hydrolyzed groups (e.g. hydroxyl group) that undergo further reactions such as condensation reaction. As used herein, the term is often used in reference to one of more groups bonded to a silicon atom in a silyl group.

The term “alkoxy” refers to a monovalent group having an oxy group bonded directly to an alkyl group.

The term “aryloxy” refers to a monovalent group having an oxy group bonded directly to an aryl group.

The terms “aralkyloxy” and “alkaryloxy” refer to a monovalent group having an oxy group bonded directly to an aralkyl group or an alkaryl group, respectively.

The term “acyloxy” refers to a monovalent group of the formula —O(CO)R^{b} where R^{b} is alkyl, aryl, aralkyl, or alkaryl. Suitable alkyl R^{b} groups often have 1 to 10 carbon atoms, 1 to 6 carbon atoms, or 1 to 4 carbon atoms. Suitable aryl R^{b} groups often have 6 to 12 carbon atoms such as, for example, phenyl. Suitable aralkyl and alkaryl R^{b} groups often have an alkyl group with 1 to 10 carbon atoms, 1 to 6 carbon atoms, or 1 to 4 carbon atoms and an aryl having 6 to 12 carbon atoms.

The term “halo” refers to a halogen atom such as fluoro, bromo, iodo, or chloro. When part of a reactive silyl, the halo group is often chloro.

The term “(meth)acryloyloxy group” includes an acryloyloxy group (—O—(CO)—CH═CH₂) and a methacryloyloxy group (—O—(CO)—C(CH₃)═CH₂).

The term “(meth)acryloylamino group” includes an acryloylamino group (—NR—(CO)—CH═CH₂) and a methacryloylamino group (—NR—(CO)—C(CH₃)═CH₂) including embodiments wherein the amide nitrogen is bonded to a hydrogen, methyl group, or ethyl group (R is H, methyl, or ethyl).

When a group is present more than once in a formula described herein, each group is “independently” selected, whether specifically stated or not. For example, when more than one R^{X1} group is present in a formula, each R group is independently selected. Furthermore, subgroups contained within these groups are also independently selected. For ample, when each R^{X1} group contains a Y group, each Y is also independently selected.

As used herein, the term “room temperature” refers to a temperature of 20° C. to 25° C. or 22° C. to 25° C.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

Description

(Epoxycyclohexyl)ethyltrimethoxysilane, available under product code SIE4670.0 from Gelest,
Incorporated, Morrisville, PA.
Glycidyloxypropyl)trimethoxysilane, available under product code SIG5840.0 from Gelest,
Incorporated, Morrisville, PA.
Methyltrimethoxysilane, available under product code SIM6560.0 from Gelest, Incorporated,
Morrisville, PA.
Mercaptopropyltrimethoxysilane, available under product code SIM6476.0 from Gelest, Incorporated,
Morrisville, PA.
Vinyltrimethoxysilane, available under product code SIV9220.0 from Gelest, Incorporated,
Morrisville, PA.
Aminopropyltrimethoxysilane, available under product code SIG5840.0 from Gelest, Incorporated,
Morrisville, PA.
Methacryloxypropyltrimethoxysilane, available under product code SIA0611.0 from Gelest,
Incorporated, Morrisville, PA.
Hexamethyldisiloxane, available under product code SIH6115.1 from Gelest, Incorporated, Morrisville,
PA.
SILQUEST A-174NT, methacryloxypropyltrimethoxysilane (greater than 90%), available the trade
designation SILQUEST A-174NT SILANE from Momentive Performance Materials, Waterford, NY.
SILQUEST A-1230, polyalkyleneoxidealkoxysilane, available the trade designation SILQUEST A-
1230 SILANE from Momentive Performance Materials, Waterford, NY.
Titanium dioxide nanoparticles, obtained as an aqueous dispersion of titanium dioxide (Brookite type)
having a pH of 4, and a solids content of 15% by weight, from Showa Denko K. K., Tokyo, Japan
PET Film, a polyester terephthalate film having a thickness of 0.002 inches (0.058 millimeters) primed
on one side, available under the trade designation HOSTAPHAN 3SAB from Mitsubishi Polyester
Film, Greer, Sc.

### Test Methods

### Refractive Index

Refractive index values of the cured SSQ/Surface Treated Nanoparticle films were measured in the following manner. Uncured dispersion blends of SSQ compounds and surface treated nanoparticles were spun coated onto silicon wafers, which had been cleaned ultrasonically in deionized water then dried in an oven for one hour at 70° C. prior to use. A 0.5 milliliter of the dispersion was first applied to the surface of the wafer while it was at rest. The wafer was then spun from rest to 4000 revolutions per minute (rpm) at a rate of 1000 (rpm)/second. It was held at 4000 rpm for twenty seconds to provide a uniform coating having a nominal thickness of 500 nanometers. The coatings were then cured as described in “Coating and Cure of the SSQ/Surface Treated Nanoparticle Compositions” further below. Reflection Spectral Ellipsometry (RSE) data was then collected on the cured coatings at incidence angle (q) increments of 5° from 55° to 75° over the wavelength range of 350 to 1000 nanometers using a ellipsometer (Model VVASE Ellipsometer from J.A. Woollam Company, Incorporated, Lincoln, Nebr.). For the analysis, the coatings were treated as a Cauchy material on the silicon dioxide layer of a silicon substrate. The silicon dioxide/silicon combination was calibrated at incidence angle (q) increments of 5° from 55° to 75° over the wavelength range of 350 to 1000 nanometers. Software was used to mathematically compare the modelled values of refractive index and extinction coefficient with the measured data until a least mean squared error solution was found. The refractive index at 593 nanometers was reported.

### Thermogravimetric Analysis (TGA)

Thermal stability of cured SSQ-nanoparticle films was evaluated in the following manner. Thermogravimetric analysis (TGA) was measured in air using a Model TGA 2950 Thermogravimetric Analyzer from TA Instruments (New Castle, Del.) from 30° C. to 600° C. with a heating rate of 10° C./minute, on a sample weighing between about 8 and 10 milligrams. The samples were taken from the coated, cured silicon wafers. The total weight loss was recorded.

### Transmittance and Haze

The total transmittance (T) and haze (H) characteristics of cured compositions on PET Film, prepared as described in “Coating and Cure of the SSQ/Surface Treated Nanoparticle Compositions”, were measured according to ASTM D-1003 “Standard Test Method for Haze and Luminous Transmittance of Transparent Plastics” using a Model HAZE-GUARD PLUS instrument from BYK Additives and Instruments, Geretsried, Germany.

### Preparation of SSQ Compounds

### Preparation of 2-(3,4-Epoxycyclohexyl)ethyl Silsesquioxane (SSQ-1)

The following were combined and stirred for 24 hours at 80° C.: 100 grams 2-(3,4-epoxycyclohexyl)ethyltrimethoxysilane, 20 grams hexamethyldisiloxane, and 50 grams deionized water. 2 After removing solvent by stripping using a vacuum pump at 50° C. for two hours SSQ-1 was obtained as clear viscous liquid in an amount of 60 grams (60% yield).

### Preparation of Glycidyloxypropyl Silsesquioxane (SSQ-2)

The following were combined and stirred for 12 hours at 70° C.: 100 grams trimethoxysilane, 20 grams hexamethyldisiloxane, and 50 grams of deionized water. After removing solvent by stripping using a vacuum pump at 50° C. for two hours SSQ-2 was obtained as clear viscous liquid in an amount of 60 grams (60% yield).

### Preparation of 2-(3,4-Epoxycyclohexyl)ethyl-co-methyl Silsesquioxane (SSQ 3)

2-(3,4-Epoxycyclohexyl)ethyl-co-methyl Silsesquioxane was prepared in the same manner as SSQ-1 with the following modifications: 70 grams 2-(3,4-epoxycyclohexyl)ethyltrimethoxysilane and 30 grams methyltrimethoxysilane were employed as the monomers. SSQ-3 was obtained as clear viscous liquid in an amount of 60 grams (60% yield).

### Preparation of Methacryloxypropyl Silsesquioxane (SSQ-4)

The following were mixed together at room temperature for between 6 and 8 hours in a 500 milliliter round bottom flask equipped with a condenser: 100 grams (0.52 moles) of methacryloxypropyltrimethoxysilane, 80 grams of deionized water containing 1 part hydrochloric acid per 1000 parts water, and 20 grams of hexamethyldisiloxane. After removing solvent by stripping using a vacuum pump at 50° C. for two hours a viscous liquid was obtained. This viscous liquid was dissolved in 100 milliliters of a mixture of isopropyl alcohol:methyl ethyl ketone/70:30 (w:w) and washed with 100 milliliters of deionized water three times. After washing, the methyl ethyl ketone was removed using a vacuum pump at 50° C. for one hour to provide 60 grams (60% yield) of SSQ-4 as tacky, viscous liquid.

### Preparation Vinylsilsesquioxane (SSQ-5)

Vinylsilsesquioxane was prepared in the same manner as SSQ-4 with the following modification: vinyltrimethoxysilane (100 g) was used in place of methacryloxypropyltrimethoxysilane. SSQ-5 (65 grams, 65% yield) was obtained as tacky, clear, viscous liquid.

### Preparation of Methacryloxypropyl-co-methyl Silsesquioxane (SSQ-6)

Methacryloxypropyl-co-methyl Silsesquioxane was prepared in the same manner as SSQ-4 with the following modifications: Mixture of 50 grams methyltrimethoxysilane and 50 grams methacryloxypropyltrimethoxsilane were employed as the monomers in place of methacryloxypropyltrimethoxysilane as sole monomer. SSQ-6 (65 grams, 65% yield) was obtained as tacky, clear, viscous liquid.

### Preparation of Mercaptopropyl Silsesquioxane (SSQ-7)

Mercaptopropyl silsesquioxane was prepared in the same manner as SSQ-4 with the following modification: Mercaptopropyltrimethoxysilane (100 g) was used in place of methacryloxypropyltrimethoxysilane. SSQ-7 (65 grams, 65% yield) was obtained as tacky, clear, viscous liquid.

### Preparation of Surface Treated (ST) Titanium Dioxide Nanoparticles

### ST-1 Nanoparticles

Titanium dioxide nanoparticles were surface treated with silane coupling agents as follows. To a 250 milliliter, three-necked flask were added with rapid stirring: 42.8 grams titanium dioxide nanoparticles, 15 grams deionized water, and 45 grams of 1-methoxy-2-propanol. Next, a mixture of 1.432 grams of SILQUEST A-174NT and 0.318 grams of SILQUEST A-1230 in 5 grams of 1-methoxy-2-propanol was slowly added with stirring followed by heating at 80° C. for 16 hours and rapid stirring. After removing the majority of solvent by stripping using a vacuum pump at room temperature for approximately four hours a white, translucent paste was obtained. This material was then diluted in a mixture of 1-methoxy-2-propanol:methyl ethyl ketone/1:1 (w:w) to give a 38% solids translucent dispersion.

### ST-2 Nanoparticles

Titanium dioxide nanoparticles were surface treated with a vinyltrimethoxysilane coupling agent using the following: To a 250 milliliter, three-necked flask were added with rapid stirring: 42.8 grams of titanium dioxide nanoparticles, 15 grams deionized water, and 45 grams of 1-methoxy-2-propanol. Next, 1.8 grams of vinyltrimethoxysilane in 5 grams of 1-methoxy-2-propanol was slowly added with stirring followed by heating at 80° C. for 16 hours and rapid stirring. After removing the majority of solvent by stripping using a vacuum pump at room temperature for approximately four hours a white, translucent paste was obtained. This material was then diluted in a mixture of 1-methoxy-2-propanol:methyl ethyl ketone/1:1 (w:w) to give a 38% solids translucent dispersion.

### ST-3 Nanoparticles

Titanium dioxide nanoparticles were surface treated with a mercaptopropyltrimethoxysilane coupling agent in the same manner as described for ST-2 Nanoparticles to give (38% solids) translucent dispersions in 1-methoxy-2-propanol:methyl ethyl ketone/1:1 (w:w).

### ST-4 Nanoparticles

Titanium dioxide nanoparticles were surface treated with art aminopropyltrimethoxysilane coupling agent in the same manner as described for ST-2 nanoparticles to give (38% solids) translucent dispersions in 1-methoxy-2-propanol:methyl ethyl ketone/1:1 (w:w).

### ST-5 Nanoparticles

Titanium dioxide nanoparticles were surface treated with a glycidyloxypropyl-trimethoxysilane coupling agent in the same manner as described for ST-2 Nanoparticles to give to give (38% solids) translucent dispersions in 1-methoxy-2-propanol:methyl ethyl ketone/1:1 (w:w).

### SSQ/Surface Treated Nanoparticle Compositions

Blends of 0.285 grams of various SSQ compounds and 5 grams of surface treated titanium dioxide nanoparticle dispersions in 5 grams of methoxypropanol were prepared by mixing aforementioned materials in 50 milliliter round bottom flask at room temperature for 30 minutes using a magnetic stirrer. The specific blend formulations are shown in Table 1.

TABLE 1

| | | | Wt-% | |
|---|---|---|---|---|
| | | | Nanopartilces | |
| | SSQ | ST | of Cured | |
| Example | Compound | Nanoparticle | Composition | Cure Type |
| 1 | SSQ-1 | ST-3 | 86.9 | Thermal |
| 2 | SSQ-2 | ST-3 | 86.9 | Thermal |
| 3 | SSQ-3 | ST-3 | 86.9 | Thermal |
| 4 | SSQ-4 | ST-3 | 86.9 | UV |
| 5 | SSQ-5 | ST-3 | 86.9 | UV |
| 6 | SSQ-6 | ST-3 | 86.9 | UV |
| 7 | SSQ-1 | ST-4 | 86.9 | Thermal |
| 8 | SSQ-2 | ST-4 | 86.9 | Thermal |
| 9 | SSQ-3 | ST-4 | 86.9 | Thermal |
| 10 | SSQ-4 | ST-4 | 86.9 | UV |
| 11 | SSQ-6 | ST-4 | 86.9 | UV |
| 12 | SSQ-7 | ST-1 | 86.9 | UV |
| 13 | SSQ-7 | ST-2 | 86.9 | UV |
| 14 | SSQ-1 | ST-5 | 86.9 | Thermal |
| 15 | SSQ-2 | ST-5 | 86.9 | Thermal |

### SSQ/Non-Surface Treated Nanoparticle Compositions (Comparative Examples)

Blends of 0.285 grams of various SSQ compounds and 5 grams of titanium dioxide nanoparticle dispersions in 5 grams of methoxypropanol were prepared by mixing aforementioned materials in a 50 milliliter round bottom flask at room temperature for 30 minutes using a magnetic stirrer. The specific blend formulations are shown in Table 2.

TABLE 2

| Comparative | | |
|---|---|---|
| Example | SSQ Compound | Cure Type |
| CE-1 | SSQ-4 | UV |
| CE-2 | SSQ-5 | UV |
| CE-3 | SSQ-6 | UV |

### Coating and Cure of the SSQ/Nanoparticle Compositions

SSQ/Surface Treated Nanoparticle Compositions and SSQ/Non-Surface Treated Nanoparticle Compositions were coated onto PET Film using a #8 Meyer rod. The coatings were dried in a vented oven at 110° C. for one minute to give a dried coating. These were then cured as follows.

Thermal Cure: Thermally curable coatings were cured in a vented oven at 120° C. for two minutes.

UV Cure: UV curable coatings were cured by passing them through a UV-chamber (Model LIGHT HAMMER 6, from Fusion UV Systems, Incorporated, Gaithersburg, Md.) equipped with an H-bulb located at 5.3 centimeters above the sample at a speed of 12 meters/minute to provide a total energy of 473 milliJoules/square centimeter.

The cured coatings of Examples 1-15 were visibly clear, tack-free, and adhered well to PET Film. The cured coatings of Comparative Examples 1-3 were visibly white and opaque. Furthermore, refractive index, transmission, and haze data for these Comparative Examples could not be obtained due to their opacity.

Refractive index, TGA, Haze, and Transmittance results are reported in Table 3 below.

TABLE 3

| | Refractive Index | TGA | | Transmittance |
|---|---|---|---|---|
| Example | (593 nm) | (% wt loss) | Haze | (%) |
| 1 | 1.86 | 10.4 | 1.66 | 92.7 |
| 2 | 1.86 | 10.2 | 1.60 | 93.0 |
| 3 | 1.89 | 10.5 | 1.64 | 92.6 |
| 4 | 1.86 | 10.7 | 1.62 | 93.1 |
| 5 | 1.86 | 9.5 | 1.67 | 92.5 |
| 6 | 1.90 | 9.5 | 1.60 | 92.9 |
| 7 | 1.90 | 9.2 | 1.71 | 91.9 |
| 8 | 1.89 | 11.3 | 1.68 | 92.4 |
| 9 | 1.88 | 11.5 | 1.66 | 92.4 |
| 10 | 1.88 | 10.1 | 1.64 | 92.2 |
| 11 | 1.88 | 11.4 | 1.64 | 92.1 |
| 12 | 1.88 | 11.0 | 1.59 | 93.1 |
| 13 | 1.90 | 9.7 | 1.65 | 92.6 |
| 14 | 1.86 | 11.5 | 1.58 | 93.2 |
| 15 | 1.88 | 11.9 | 1.61 | 93.0 |
| CE1 | * | 9.4 | * | * |
| CE2 | * | 9.5 | * | * |
| CE3 | * | 9.4 | * | * |

* unable to obtain due to opacity of samples

1. A curable composition comprising:
a silsesquioxane polymer comprising first non-hydrolyzed functional groups;
inorganic oxide nanoparticles; and
at least one surface treatment compound comprising a second functional group wherein the second functional groups covalently bond with the first non-hydrolyzed functional groups of the silsesquioxane polymer.

2. The curable composition of claim 1 wherein the silsesquioxane polymer comprises a three-dimensional branched network having the formula: 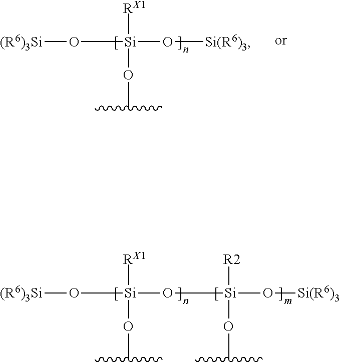
wherein:
the oxygen atom at the * is bonded to another Si atom within the three-dimensional branched network;
R^{X1} is independently the first non-hydrolyzed functional group;
R² is a substituent that does not covalently bonded with the second functional group of the surface treatment compound;
R⁶ is a hydrolyzable group, a non-hydrolyzed group, or a combination thereof; and
n or n+m is an integer of greater than 3.

3. The curable composition of claim 1 wherein the first non-hydrolyzed functional groups are independently selected from an ethylenically unsaturated group, epoxy, mercapto, amino, and isocyanato.

4. The curable composition of claim 2 wherein n or n+m is an integer of no greater than 200.

5. The curable composition of claim 1 wherein the at least one surface treatment compound has the general structure
R^{X2}—(CH₂)n-Si(R⁵)₃
wherein R^{X2} is the second functional group and R⁵ is a hydrolyzable group.

6. The curable composition of claim 5 wherein R⁵ bonds the surface treatment compound to the inorganic nanoparticles.

7. The curable composition of claim 1 wherein R^{X2} is selected from an ethylenically unsaturated group, epoxy, mercapto, amino, and isocyanato.

8. The curable composition of claim 2 wherein R⁶ is a non-hydrolyzed group independently selected from alkyl, aryl, aralkyl, alkaryl, optionally comprising substituents.

9. The curable composition of claim 1 wherein the silsesquioxane polymer comprises —OH groups present in an amount no greater than 5 wt-% of the silsesquioxane polymer.

10. The curable composition of claim 1 wherein the silsesquioxane polymer is free of —OH groups.

11. The curable composition of claim 1 wherein the cured composition has a weight loss of less than 20% or 15% when heated 30° C. to 600° C. at a heating rate of 10° C./minute.

12. The curable composition of claim 1 wherein the inorganic oxide nanoparticles have a refractive index of at least 1.68.

13. The curable composition of claim 1 further comprising organic solvent.

14. The curable composition of claim 1 wherein the first and second functional groups covalently bond after drying and/or curing.

15. A method of making an article comprising
disposing the curable composition of claim 1 on at least a portion of at least one surface of a substrate; and
thermally and/or radiation curing the curable composition such the first and second functional groups covalently bond.

16. An article comprising a substrate and the curable composition of claim 1 disposed on at least a portion of at least one surface of the substrate.

17. An article comprising a substrate and a cured composition of claim 1 disposed on at least a portion of at least one surface of the substrate.

18. An article comprising a substrate and a cured composition disposed on at least a portion of at least one surface of the substrate wherein the cured composition comprises inorganic oxide nanoparticles covalently bonded to non-hydrolyzed functional groups of a silsesquioxane polymer matrix.
